(19) United States
(12) Patent Application Publication
(10) Pub. No.: US 2020/0304561 A1
(43) Pub. Date: Sep. 24, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Taro YOSHIHAMA, Kanagawa (JP)

(73) Assignee: FUJI XEROX CO., LTD., Tokyo (JP)

(21) Appl. No.: 16/526,325

(22) Filed: Jul. 30, 2019

(30) Foreign Application Priority Data
Mar. 20, 2019 (JP) 2019-053818

(51) Int. Cl. H04L 29/08

(52) U.S. Cl. CPC H04L 67/10

(57) ABSTRACT

An information processing apparatus includes an accepting unit, a first controller, an executing unit, and a second controller. The accepting unit accepts from a terminal apparatus of a first user an instruction to perform a predetermined operation on data stored in an external apparatus. In accordance with the instruction accepted by the accepting unit, the first controller performs control to retrieve the data from the external apparatus and store the data in a storage unit in the information processing apparatus. The executing unit performs the operation on the data, which is stored in the storage unit, in accordance with the instruction. The second controller performs control to store in the external apparatus the data on which the operation has been performed by the executing unit in accordance with the instruction.

### CROSS-REFERENCE TO RELATED APPLICATIONS

This application is based on and claims priority under 35 USC 119 from Japanese Patent Application No. 2019-053818 filed Mar. 20, 2019.

### BACKGROUND

### (i) Technical Field

The present disclosure relates to an information processing apparatus and a non-transitory computer readable medium.

### (ii) Related Art

Japanese Unexamined Patent Application Publication No. 2018-97861, for example, describes a cloud storage management method for a cloud storage management system realized by using a computer. In this cloud storage management method, a network drive is configured for first cloud storage that is allocated to an user of an electronic device and that is located on a server associated with the cloud storage management system, second cloud storage on at least one different server used by the user is operated in combination, and the first cloud storage and the second cloud storage are integrally managed via the network drive.

Japanese Patent No. 5853996 describes an information system that communicates with a plurality of cloud servers. This information system includes an information management unit and an acquiring unit. The information management unit manages account information representing accounts owned by a user of the information system, and each of the accounts corresponds to one of the plurality of cloud servers. Upon user login, the acquiring unit accesses the plurality of cloud serves by using the account information and acquires from each of the plurality of cloud servers usage information indicating the way in which the user uses the cloud server. The information system also includes a user interface unit that causes a display included in a device operated by the user upon login to present a list of the ways in which the plurality of cloud servers are individually used by the user, the ways being indicated by the usage information.

Japanese Patent No. 6345770 describes a method of providing application integration for a sync framework executing on a computing device storing a first instance of a file. The computing device is in communication via a network with a cloud, and the cloud stores a second instance of the file and includes a sync engine. The method includes a step in which an update to the first instance of the file is allowed and an update to the second instance is allowed during a certain period. The method includes a step in which, responsive to the updates to the first instance and the second instance of the file during the period, synchronization between the first instance of the file and the second instance of the file is automatically maintained by exchanging via a network updates between the sync framework and the sync engine, the sync framework including an interface or application programming interface (API) to allow arbitrary applications executing on the computing device to communicate with the sync framework. In addition, the method includes a step in which a sync-lock request associated with the file is received via the interface or API from a first application executing on the computing device. Further, the method includes a step in which, responsive to the sync-lock request, a sync-lock including temporarily relinquishing synchronization between the first and second instances of the file by the sync framework is provided, and updating the first and second instances of the file continues to be allowed while the sync-lock request is being issued.

### SUMMARY

When a specific operation such as a cooperative edit is performed on data stored in an external apparatus, a user having a terminal that is an information processing apparatus supporting the specific operation performs an operation to download the data from the external apparatus to the terminal of the user and performs an operation to upload the data onto the external apparatus after performing the specific operation. A user having a terminal that is not an information processing apparatus supporting the specific operation is required to perform an operation to upload the data onto an information processing apparatus supporting the specific operation and is required to perform an operation to download the data to the terminal of the user again after performing the specific operation. Then, the user is required to perform an operation to upload the data onto the external apparatus. In this way, when a specific operation is performed on data stored in an external apparatus, a user is required to perform cumbersome operations such as download and upload of the data in addition to the specific operation, and efficiently performing the specific operation is difficult.

Aspects of non-limiting embodiments of the present disclosure relate to providing an information processing apparatus and a non-transitory computer readable medium that enable the user to perform a specific operation on data stored in an external apparatus. When the specific operation is performed on the data stored in the external apparatus, the information processing apparatus and the non-transitory computer readable medium reduce the amount of operational load for a user compared with a case where the user performs an operation to download the data stored in the external apparatus and to upload the data onto the external apparatus after performing the specific operation on the downloaded data by using a terminal of the user supporting the specific operation or by using an information processing apparatus supporting the specific operation.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an accepting unit, a first controller, an executing unit, and a second controller. The accepting unit accepts from a terminal apparatus of a first user an instruction to perform a predetermined operation on data stored in an external apparatus. In accordance with the instruction accepted by the accepting unit, the first controller performs control to retrieve the data from the external apparatus and store the data in a storage unit in the information processing apparatus. The executing unit performs the operation on the data, which is stored in the storage unit, in accordance with the instruction. The second controller performs control to store in the external apparatus the data on which the operation has been performed by the executing unit in accordance with the instruction.

### BRIEF DESCRIPTION OF THE DRAWINGS

An exemplary embodiment of the present disclosure will be described in detail based on the following figures, wherein:

FIG. 1 is a block diagram depicting an example configuration of an information processing system according to the exemplary embodiment;

FIG. 2 is a block diagram depicting an example electrical configuration of an information processing apparatus according to the exemplary embodiment;

FIG. 3 is a block diagram depicting an example functional configuration of the information processing apparatus according to the exemplary embodiment;

FIG. 4 is a flowchart depicting an example processing flow of a data management program according to the exemplary embodiment;

FIG. 5A is a schematic diagram depicting the relation between check-out and check-in in a case of a cooperative edit according to the exemplary embodiment, and FIG. 5B is a schematic diagram depicting the relation between check-out and check-in in a case of an ordinary edit according to a comparative example;

FIG. 6 is a sequence chart depicting an example flow of cooperative edit processing performed by using the information processing apparatus according to the exemplary embodiment;

FIG. 7A and FIG. 7B are schematic diagrams each of which depicts an example folder structure of a storage unit according to the exemplary embodiment; and

FIG. 8 is a front view depicting an example acceptance screen according to the exemplary embodiment.

### DETAILED DESCRIPTION

Hereinafter, an exemplary embodiment for practicing the present disclosure will be described in detail with reference to the drawings.

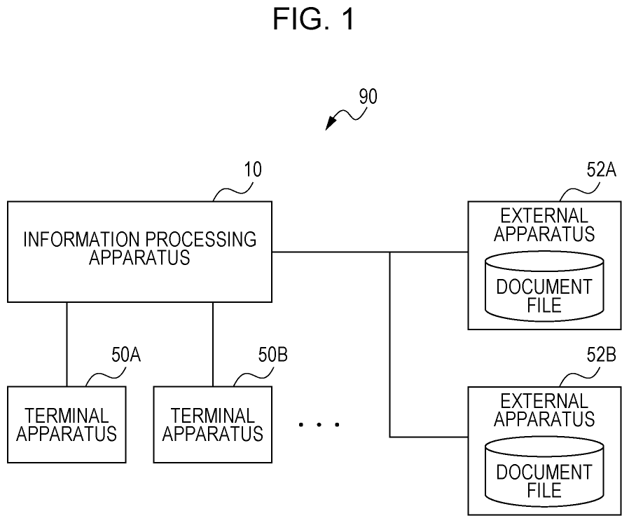

FIG. 1 is a block diagram depicting an example configuration of an information processing system 90 according to the present exemplary embodiment. As depicted in FIG. 1, the information processing system 90 according to the present exemplary embodiment includes an information processing apparatus 10, a plurality of terminal apparatuses 50A, 50B, . . . , and a plurality of external apparatuses 52A, 52B, . . . .

A general-purpose computing device, such as a personal computer (PC) or a server computer, is used as the information processing apparatus 10 according to the present exemplary embodiment. The information processing apparatus 10 may be used on a cloud platform or on an on-premises platform. A cloud platform is a platform on which an entity such as an enterprise uses outside computer resources via the Internet, and an on-premises platform is a platform on which an entity such as an enterprise owns and uses computer resources of its own. The information processing apparatus 10 is connected to the plurality of terminal apparatuses 50A, 50B, . . . via a network, and to the plurality of external apparatuses 52A, 52B, . . . via a network at the same time. Examples of the network include the Internet, a local area network (LAN), and a wide area network (WAN).

Examples of the plurality of terminal apparatuses 50A, 50B, . . . according to the present exemplary embodiment include various kinds of devices that a user uses, such as a PC, a smartphone, and a tablet terminal. Hereinafter, when it is unnecessary to describe the plurality of terminal apparatuses 50A, 50B, . . . individually, the plurality of terminal apparatuses 50A, 50B, . . . are collectively referred to as the terminal apparatuses 50.

Examples of the plurality of external apparatuses 52A, 52B, . . . according to the present exemplary embodiment include general-purpose computing devices, such as server computers. Hereinafter, when it is unnecessary to describe the plurality of external apparatuses 52A, 52B, . . . individually, the plurality of external apparatuses 52A, 52B, . . . are collectively referred to as the external apparatuses 52. A plurality of apparatuses are unnecessary as the external apparatuses 52, and at least one installed apparatus is sufficient. Similarly to the information processing apparatus 10, the external apparatuses 52 may be used on a cloud platform or on an on-premises platform.

Each of the external apparatuses 52 has a function as an external storage unit that stores document files, each of which is an example of data. Each of the external apparatuses 52 has a check-out function and a check-in function. A check-out function is a function to download a document file from one of the external apparatuses 52 to the information processing apparatus 10 and to automatically lock the document file in the one of the external apparatuses 52 (that is, a function to forbid other people from using the document file in the one of the external apparatuses 52). On the other hand, a check-in function is a function to upload a document file from the information processing apparatus 10 onto one of the external apparatuses 52 and to automatically unlock the document file in the one of the external apparatuses 52 (that is, a function to allow other people to use the document file in the one of the external apparatuses 52). In some case, a document file is manually locked or unlocked, and locking and unlocking a document file automatically or manually are referred to as a check-out function and a check-in function.

The present exemplary embodiment will be described under the assumption that the information processing apparatus 10 and the terminal apparatuses 50 are connected to each other via a LAN and the information processing apparatus 10 and the external apparatuses 52 are connected to each other via the Internet.

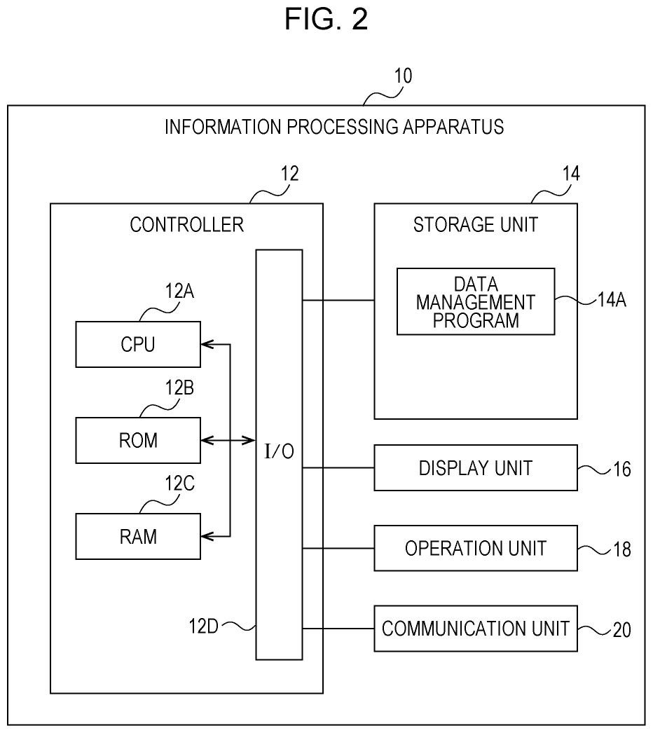

FIG. 2 is a block diagram depicting an example electrical configuration of the information processing apparatus 10 according to the present exemplary embodiment. As depicted in FIG. 2, the information processing apparatus 10 according to the present exemplary embodiment includes a controller 12, a storage unit 14, a display unit 16, an operation unit 18, and a communication unit 20.

The controller 12 includes a central processing unit (CPU) 12A, a read-only memory (ROM) 12B, a random-access memory (RAM) 12C, and an input/output interface (I/O) 12D, which are connected to each other via a bus.

Functional units including the storage unit 14, the display unit 16, the operation unit 18, and the communication unit 20 are connected to the I/O 12D. Each of the functional units is allowed to mutually communicate with the CPU 12A via the I/O 12D.

The controller 12 may be configured as a sub-controller that controls a partial operation of the information processing apparatus 10 or may be configured as a portion of the main controller that controls the entire operation of the information processing apparatus 10. Some blocks or all the blocks of the controller 12 include, for example, an integrated circuit (IC), such as a large scale integrated circuit (LSI), or an IC chipset. A discrete circuit may be used for each of the blocks, or a partially integrated circuit or an entirely integrated circuit may be used for each of the blocks. All the blocks described above may be disposed as a single unit, or some of the blocks may be separately disposed. Alternatively, a portion of each of the blocks may be separately disposed. Integration of the controller 12 may be achieved not only by using an LSI but also by using a dedicated circuit or a general-purpose processor.

Examples of the storage unit 14 to be used include a hard disk drive (HDD), a solid state drive (SSD), and a flash memory. A data management program 14A according to the present exemplary embodiment is stored in the storage unit 14. The data management program 14A may be stored in the ROM 12B. The data management program 14A is realized as a function of a document management software application, such as DocuWorks (registered trademark) of Fuji Xerox Co., Ltd.

The data management program 14A may be installed in advance, for example, on the information processing apparatus 10. The data management program 14A may be recorded on a nonvolatile recording medium or distributed via a network and installed on the information processing apparatus 10 as appropriate to realize the function. Examples of a nonvolatile recording medium are expected to include a compact disc read-only memory (CD-ROM), a magneto-optic disk, an HDD, a digital versatile disc read-only memory (DVD-ROM), a flash memory, and a memory card.

Examples of the display unit 16 to be used include a liquid crystal display (LCD) and an organic electroluminescent (EL) display. The display unit 16 may include a touch panel as an integral component. The operation unit 18 includes devices used for receiving an operation, such as a keyboard and a mouse. The display unit 16 and the operation unit 18 accept various instructions from a user of the information processing apparatus 10. The display unit 16 displays various kinds of information such as a result of processing performed in accordance with an instruction accepted from a user and a notification relating to processing.

The communication unit 20 is connected to networks such as the Internet, a LAN, and a WAN and allowed to communicate with each of the terminal apparatuses 50 and each of the external apparatuses 52 via the networks.

As described above, when a user performs a specific operation on a document file stored in one of the external apparatuses 52, if the terminal apparatus 50 of the user is an information processing apparatus that does not support the specific operation to be performed on the downloaded document file, in some case, the user performs an operation to download the document file, which is stored in one of the external apparatuses 52, upload the document file onto an information processing apparatus supporting the specific operation, perform the specific operation on the document file, download the document file to the terminal apparatus 50 of the user again, and then upload the document file, on which the specific operation has been performed, onto the one of the external apparatuses 52. In this case, a user is required to perform cumbersome operations such as download and upload of the document file in addition to the specific operation, and efficiently performing the specific operation is difficult. Examples of the specific operation mentioned here include a review and an edit of a document file in a special format and a cooperative edit of a document file performed by a plurality of users.

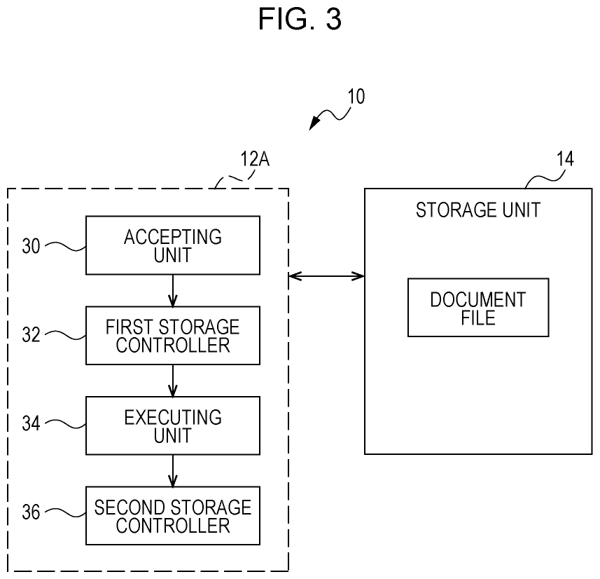

For these purposes, the CPU 12A in the information processing apparatus 10 according to the present exemplary embodiment loads the data management program 14A stored in the storage unit 14 into the RAM 12C and executes the data management program 14A, thereby functioning as each unit depicted in FIG. 3.

FIG. 3 is a block diagram depicting an example functional configuration of the information processing apparatus 10 according to the present exemplary embodiment. As depicted in FIG. 3, the CPU 12A of the information processing apparatus 10 according to the present exemplary embodiment functions as an accepting unit 30, a first storage controller 32, an executing unit 34, and a second storage controller 36. The first storage controller 32 is an example of a first controller, and the second storage controller 36 is an example of a second controller. In the present exemplary embodiment, the first storage controller 32 and the second storage controller 36 will separately be described, but these storage controllers may be realized as a single storage controller.

The accepting unit 30 according to the present exemplary embodiment accepts from the terminal apparatus 50 of a user an instruction to perform a specific operation on a document file stored in one of the external apparatuses 52. In the present exemplary embodiment, a description will be given by taking a document file containing text as an example of data, but data on which an operation is performed is not limited to text and may be an image or the like.

The first storage controller 32 according to the present exemplary embodiment performs control to download the document file from the one of the external apparatuses 52 and store the document file in the storage unit 14 in the information processing apparatus 10 in accordance with the instruction accepted by the accepting unit 30. In the present exemplary embodiment, the document file is copied from the one of the external apparatuses 52 to the storage unit 14. The storage unit 14 depicted in FIG. 3 stores the document file, which has been downloaded from the one of the external apparatuses 52.

The executing unit 34 according to the present exemplary embodiment performs the specific operation on the document file, which is stored in the storage unit 14, in accordance with the instruction accepted by the accepting unit 30.

The second storage controller 36 according to the present exemplary embodiment performs control to upload onto the one of the external apparatuses 52 the document file, on which the operation has been performed by the executing unit 34 in accordance with the instruction, and store the document file in the one of the external apparatuses 52. In the present exemplary embodiment, the document file is copied from the storage unit 14 to the one of the external apparatuses 52.

In summary, when a user performs a specific operation on a document file stored in one of the external apparatuses 52, the user is only required to instruct the information processing apparatus 10 to perform the specific operation. Thus, since the user is not required to perform cumbersome operations such as download and upload of the document file in addition to performing the specific operation, the amount of operational load for a user is reduced, and the specific operation is efficiently performed.

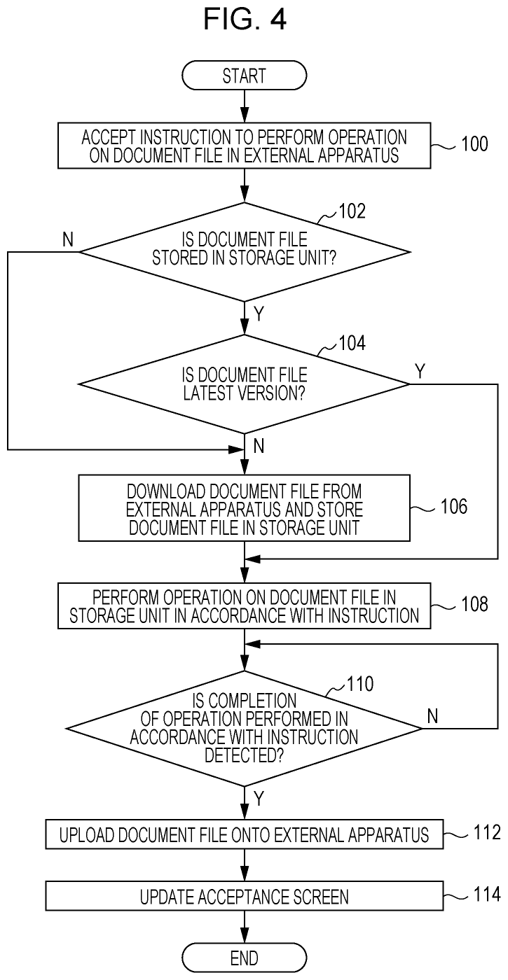

Next, an operation of the information processing apparatus 10 according to the present exemplary embodiment will be described with reference to FIG. 4. FIG. 4 is a flowchart depicting an example processing flow of the data management program 14A according to the present exemplary embodiment.

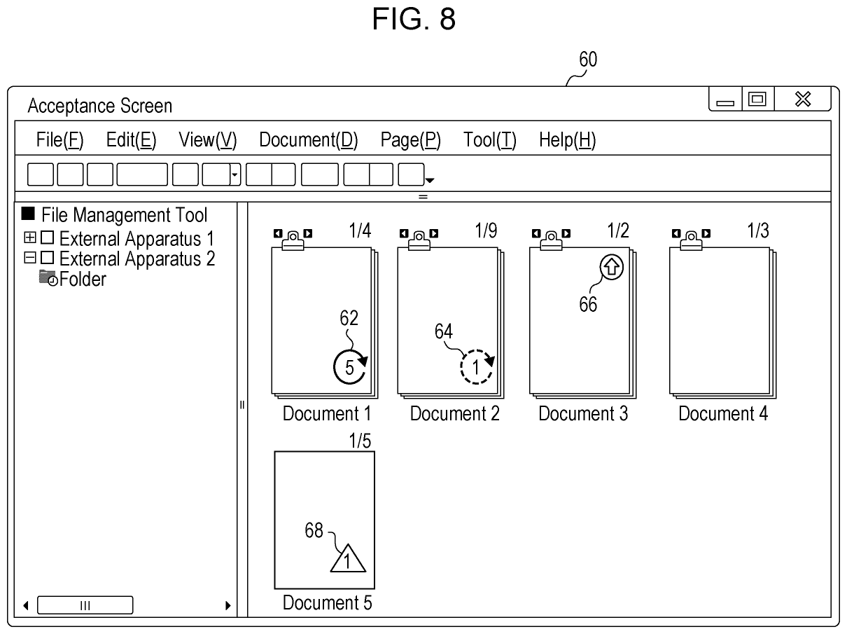

An acceptance screen, which is depicted, for example, in FIG. 8 described below, is displayed by the terminal apparatus 50 of a user, and the acceptance screen enables the user to specify a document file stored in the external apparatuses 52 and to input an instruction to perform a specific operation. The specific operation described here is, for example, an operation relating to a cooperative edit of a document file performed by a plurality of users.

In step 100 in FIG. 4, the accepting unit 30 accepts from the terminal apparatus 50 of a first user an instruction to perform a specific operation on a document file that is specified among a plurality of document files stored in the external apparatuses 52, hereinafter the document file being referred to as the “specified document file”. When accepting from the terminal apparatus 50 of the first user the instruction to perform the operation on the specified document file, the accepting unit 30 accepts the result of a choice between whether the specified document file is used by a single user or by a plurality of users. In a case of a cooperative edit, the accepting unit 30 accepts the result that the specified document file is used by a plurality of users.

In step 102, the first storage controller 32 determines whether the specified document file is stored in the storage unit 14. If it is determined that the specified document file is stored in the storage unit 14 (determined in the affirmative), the process proceeds to step 104, and if it is determined that the specified document file is not stored in the storage unit 14 (determined in the negative), the process proceeds to step 106.

In step 104, the first storage controller 32 determines whether the specified document file stored in the storage unit 14 is the latest version. Specifically, the specified document file stored in one of the external apparatuses 52 and the specified document file stored in the storage unit 14 are compared with each other, and it is determined whether the specified document file in the storage unit 14 is the latest version. It is determined whether the specified document file in the storage unit 14 is the latest version by comparing, for example, the date and time of update, the version, or the like of the specified document files in the one of the external apparatuses 52 and in the storage unit 14. If the date and time of update and/or the version are the same for both the document files, it is determined that the specified document file in the storage unit 14 is the latest version. If it is determined that the specified document file in the storage unit 14 is the latest version (determined in the affirmative), the process proceeds to step 108, and if it is determined that the specified document file in the storage unit 14 is not the latest version (determined in the negative), the process proceeds to step 106.

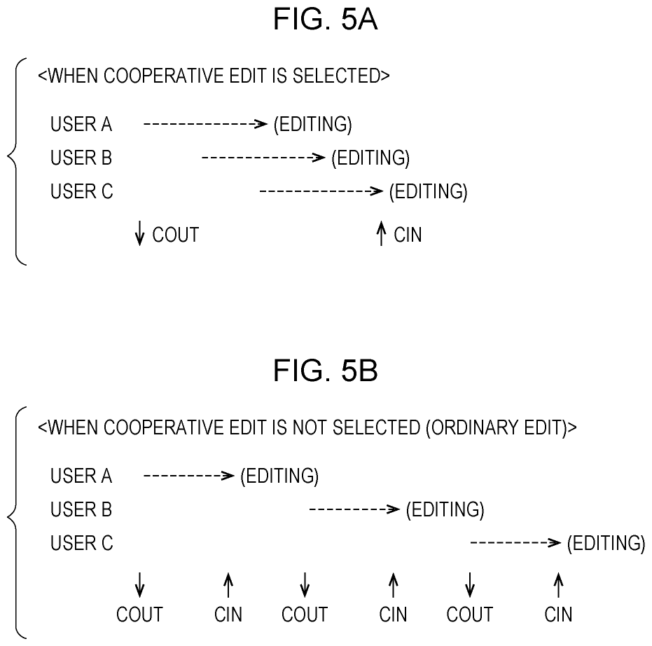

In step 106, the first storage controller 32 performs control to download the specified document file from the one of the external apparatuses 52 and store the specified document file in the storage unit 14. At this time, if a version of the specified document file is already stored in the storage unit 14, the specified document file downloaded from the one of the external apparatuses 52 overwrites the existing version and is stored. Upon storing in the storage unit 14 the specified document file, which has been downloaded from the one of the external apparatuses 52, the first storage controller 32 performs control to forbid the specified document file from being used in the one of the external apparatuses 52 (that is, check-out is performed). Referring to FIG. 5A and FIG. 5B, the relation between check-out and check-in in a case of a cooperative edit will be described.

FIG. 5A is a schematic diagram depicting the relation between check-out and check-in in a case of a cooperative edit according to the present exemplary embodiment. FIG. 5B is a schematic diagram depicting the relation between check-out and check-in in a case of an ordinary edit according to a comparative example.

In the case of a cooperative edit by a user A, a user B, and a user C as depicted in FIG. 5A, check-out (COUT) is performed in response to an instruction from the user A, and check-in (CIN) is performed in response to an instruction from the user C, who is the last user. On the other hand, in the case of an ordinary edit (exclusive edit) by the user A, the user B, and the user C as depicted in FIG. 5B, check-out (COUT) and check-in (CIN) are performed separately by the user A, the user B, and the user C.

Next, in step 108, the executing unit 34 performs the specific operation on the specified document file, which is stored in the storage unit 14, in accordance with the instruction accepted in step 100. If it is determined in step 104 that the specified document file in the storage unit 14 is the latest version, the control to download the specified document file stored in the one of the external apparatuses 52 and store the specified document file in the storage unit 14 is not performed. Thus, the operation is performed on the specified document file in the storage unit 14 as it is in accordance with the instruction.

If the specific operation is a cooperative edit, in step 108 described above, the accepting unit 30 accepts from the terminal apparatus 50 of a second user an instruction to perform an operation on the specified document file stored in the storage unit 14, as depicted by the example in FIG. 5A described above. The second user (the user B or the user C in the example in FIG. 5A) differs from the first user (the user A in the example in FIG. 5A), who issues the instruction in step 100. Then, the executing unit 34 performs the operation on the specified document file in accordance with the instruction accepted from the terminal apparatus 50 of the second user.

In step 110, the second storage controller 36 determines whether the completion of the operation is detected. The operation is performed on the specified document file, which is stored in the storage unit 14, in accordance with the instruction. Specifically, if the specific operation is a cooperative edit, the user who performs an operation of closing the specified document file being edited is the last user. In other words, the completion of the operation performed on the specified document file in accordance with the instruction is detected by detecting the operation of closing the specified document file performed by the last user. If it is determined that the completion of the operation performed on the specified document file in accordance with the instruction is detected (determined in the affirmative), the process proceeds to step 112, and if it is determined that the completion of the operation performed on the specified document file in accordance with the instruction is not detected (determined in the negative), the process stays in step 110.

In step 112, the second storage controller 36 performs control to upload onto the one of the external apparatuses 52 the specified document file, on which the operation has been performed in step 108 in accordance with the instruction, and store the specified document file in the one of the external apparatuses 52. Specifically, upon detecting the completion of the operation performed in accordance with the instruction accepted from the terminal apparatus 50 of the last user on the specified document file being cooperatively edited, the second storage controller 36 performs control to store the specified document file in the one of the external apparatuses 52. After storing in the one of the external apparatuses 52 the specified document file, on which the operation has been performed in accordance with the instruction, the second storage controller 36 performs control to allow the specified document file to be used in the one of the external apparatuses 52 (that is, check-in is performed).

After the second storage controller 36 stores in the one of the external apparatuses 52 the specified document file, on which the operation has been performed in accordance with the instruction, if the specified document file in the one of the external apparatuses 52 is updated, the second storage controller 36 may perform control to delete the specified document file stored in the storage unit 14.

In step 114, the accepting unit 30 updates the acceptance screen depicted, for example, in FIG. 8 described below and, a series of processes executed by the data management program 14A is completed.

In the above description, an example of the cooperative edit is described as the specific operation, and a review and an edit of a document file in a special format are performed similarly. In such a case, a dedicated application program for reviewing and editing is stored in advance in the information processing apparatus 10 to enable a user to review and edit a document file in the special format. Thus, simply issuing from the terminal apparatus 50 of the user to the information processing apparatus 10 an instruction to perform an operation to review and edit a document file is sufficient to cause the information processing apparatus 10 to automatically download, display, edit, and upload the document file.

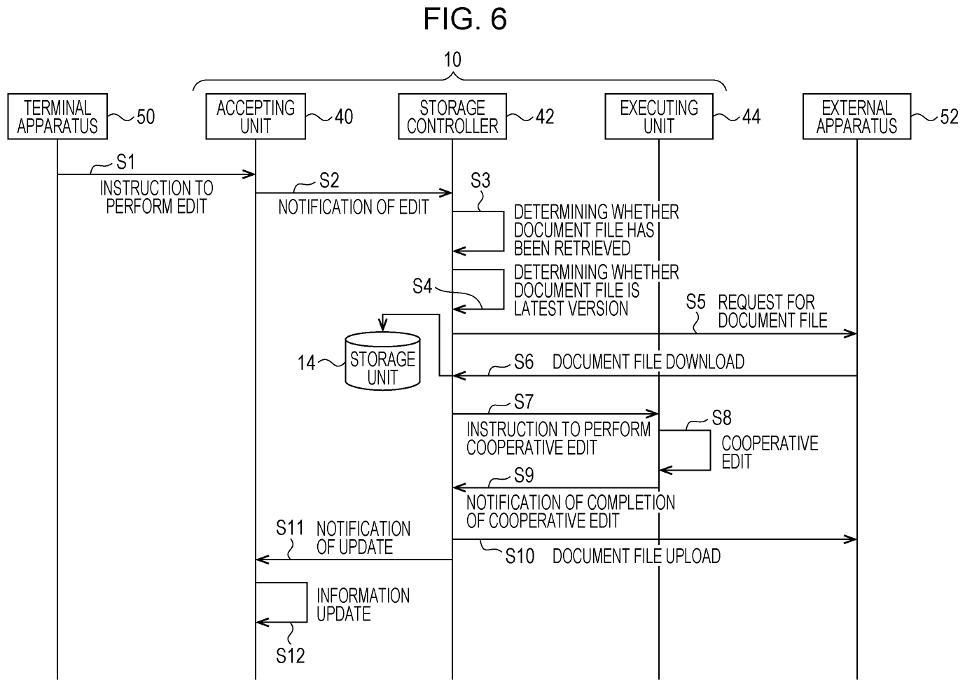

Next, cooperative edit processing performed by using the information processing apparatus 10 according to the present exemplary embodiment will more specifically be described with reference to FIG. 6 to FIG. 8.

FIG. 6 is a sequence chart depicting an example flow of the cooperative edit processing performed by using the information processing apparatus 10 according to the present exemplary embodiment. As depicted in FIG. 6, the information processing apparatus 10 includes an accepting unit 40, a storage controller 42, and an executing unit 44. The accepting unit 40 has a function similar to the function of the accepting unit 30 described above, and the executing unit 44 has a function similar to the function of the executing unit 34. Here, the first controller and the second controller will be described as a single storage controller 42.

The accepting unit 40 displays and manages content of a plurality of document files stored in the external apparatuses 52 and accepts an instruction to perform an exclusive edit or a cooperative edit on a document file specified by a user. The accepting unit 40 may be disposed in the terminal apparatuses 50 instead of the information processing apparatus 10.

Specifically, the accepting unit 40 manages folder structures of the external apparatuses 52, information about files stored in the external apparatuses 52, and the like. The information about a file includes items relating to a document file, such as a thumbnail image, the date and time of update, the date and time of creation, the number of pages, and the access right in the external apparatuses 52.

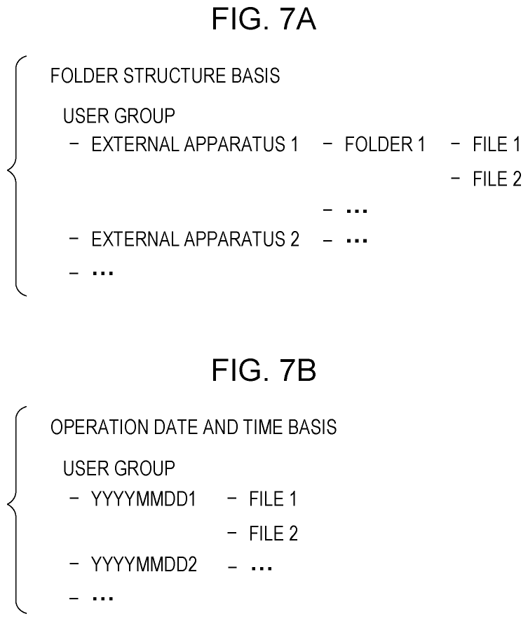

As described above, the storage controller 42 controls download and upload of a document file specified by the user among a plurality of document files stored in the external apparatuses 52. The storage controller 42 manages folder structures of the storage unit 14 as depicted, for example, in FIG. 7A and FIG. 7B.

FIG. 7A and FIG. 7B are schematic diagrams each of which depicts an example folder structure of the storage unit 14 according to the present exemplary embodiment. FIG. 7A depicts a folder structure of the storage unit 14 based on the folder structure for document files stored in each of the plurality of external apparatuses 52 (represented by an external apparatus 1 and an external apparatus 2 in this example). FIG. 7B depicts a folder structure of the storage unit 14 based on the date and time of operation of each of the document files stored in each of the plurality of external apparatuses 52.

The storage unit 14 stores a large number of document files copied from the external apparatuses 52. Thus, document files on which an operation has not been performed for a certain period, document files edited by using the external apparatuses 52, and the like among the document files stored in the storage unit 14 may regularly be deleted. Alternatively, a document file may temporarily be copied onto the storage unit 14 and deleted immediately after the completion of edit processing.

The storage controller 42 manages user identification (ID) and passwords for each of the external apparatuses 52. The storage controller 42 manages for each document file stored in the storage unit 14 an identification number of one of the external apparatuses 52, file ID (such as a uniform resource locator (URL)) in the one of the external apparatuses 52, the date and time of update of the file, the access right for the file, file ID (such as a URL) in the storage unit 14, and the like.

The executing unit 44 has an editing function for performing an exclusive edit or a cooperative edit on a document file that the storage controller 42 downloads from the external apparatuses 52 and stores in the storage unit 14.

Referring back to FIG. 6, in step S1, the accepting unit 40 accepts from the terminal apparatus 50 of a user an instruction to perform a cooperative edit on a document file that is specified by the user among a plurality of document files stored in the external apparatuses 52. A document file is specified by using the display of an acceptance screen depicted, for example, in FIG. 8.

FIG. 8 is a front view depicting an example of an acceptance screen 60 according to the present exemplary embodiment. The acceptance screen 60 depicted in FIG. 8 is displayed by the terminal apparatus 50 under the control of the accepting unit 40. In the acceptance screen 60, the plurality of external apparatuses 52 are represented by the external apparatus 1 and the external apparatus 2 for convenience.

The acceptance screen 60 depicted in FIG. 8 presents thumbnail images representing a plurality of document files (five document files from a document 1 to a document 5 in the example in FIG. 8) stored in a folder 1 in the external apparatus 1 of the external apparatuses 1 and 2.

An icon 62, which indicates that the document is being edited by the user of the terminal apparatus 50, is attached to the document 1. The number in the icon 62 (“5” in the example in FIG. 8) indicates the number of users who are editing the document 1. Specifically, the icon 62 indicates that five users including the user of the terminal apparatus 50 are cooperatively editing the document 1.

An icon 64, which indicates that the document is being edited by other users, is attached to the document 2. The number in the icon 64 (“1” in the example in FIG. 8) indicates the number of other users who are editing the document 2. Specifically, the icon 64 indicates that another user is editing the document 2.

An icon 66, which indicates that the document is not stored in the storage unit 14, namely the document has not been downloaded from the external apparatus 1, is attached to the document 3. In contrast to this, the documents 1, 2, 4, and 5, to which the icon 66 is not attached, are stored in the storage unit 14, namely the documents have been downloaded from the external apparatus 1.

No icon is attached to the document 4. The document 4, to which no icon is attached, is stored in the storage unit 14 and allows a cooperative edit.

An icon 68, which indicates that only an exclusive edit is allowed, is attached to the document 5. In other words, the document 5, to which the icon 68 is attached, allows only an exclusive edit and forbids a cooperative edit.

As described above, the acceptance screen 60 includes thumbnails each of which represents one of the plurality of document files stored in the external apparatus 1. The accepting unit 40 causes the terminal apparatus 50 to display the acceptance screen 60 and accepts an instruction to a document file selected as an operation target from the plurality of document files stored in the external apparatus 1.

In addition, the acceptance screen 60 presents the plurality of document files stored in the external apparatus 1 in a manner that enables the user to distinguish a document file stored in the storage unit 14 from a document file that is not stored in the storage unit 14.

Specifically, for example, a document file is distinguished in accordance with whether the icon 66 is attached to the thumbnail of the document file.

Further, the acceptance screen 60 presents the number of users each of whom is issuing an instruction to perform a specific operation on a document file stored in the storage unit 14. Specifically, for example, the number in the icon 62 and the number in the icon 64 each indicate the number of users.

The acceptance screen 60 also presents each of the document files stored in the storage unit 14 in a manner that enables the user to determine whether the document file allows a cooperative edit. Specifically, for example, a document file that allows a cooperative edit is distinguished in accordance with whether the icon 68 is attached to the document file.

When an instruction to perform an operation on a document file is accepted on the acceptance screen 60, the user may be allowed to determine whether the operation is performed in accordance with the instruction on a document file stored in one of the external apparatuses 52 or on a document file stored in the storage unit 14.

Next, referring back to FIG. 6, in step S2, the accepting unit 40 notifies the storage controller 42 that a cooperative edit of a document file is performed. The document file (specified document file) is specified by the user via the acceptance screen 60 depicted, for example, in FIG. 8.

In step S3, the storage controller 42 determines whether the specified document file has been retrieved from the external apparatuses 52, namely whether the specified document file is stored in the storage unit 14. If it is determined that the specified document file has been retrieved from the external apparatuses 52, the process proceeds to step S4, and if it is determined that the specified document file has not been retrieved from the external apparatuses 52, the process proceeds to step S5.

In step S4, the storage controller 42 compares the specified document file stored in the storage unit 14 and a target document file stored in one of the external apparatuses 52 and determines whether the specified document file in the storage unit 14 is the latest version. Whether the specified document file is the latest version is determined in accordance with, for example, the date and time of update, the version, and the like of the specified document file. If it is determined that the specified document file in the storage unit 14 is the latest version, the process proceeds to step S7, and if it is determined that the specified document file in the storage unit 14 is not the latest version, the process proceeds to step S5.

In step S5, the storage controller 42 sends to one of the external apparatuses 52 a request for downloading the specified document file.

In step S6, the storage controller 42 performs control to download the specified document file from the one of the external apparatuses 52 and store the downloaded specified document file in the storage unit 14. As described above, upon storing the specified document file in the storage unit 14, the storage controller 42 performs control to forbid the specified document file from being used in the one of the external apparatuses 52 (that is, check-out is performed). If the specified document file in the one of the external apparatuses 52 is not updated after the previous download of the specified document file, the download from the one of the external apparatuses 52 is unnecessary.

In step S7, the storage controller 42 instructs the executing unit 44 to perform a cooperative edit. At this time, the storage controller 42 manages information about the specified document file to be cooperatively edited, such as a URL and the date and time of update. When receiving from another user via the accepting unit 40 an instruction to perform a cooperative edit on the same specified document file, the storage controller 42 skips the processing from step S3 to step S6 described above and instructs the executing unit 44 to perform a cooperative edit. At this time, the same specified document file stored in the one of the external apparatuses 52 is being subjected to check-out and thus does not allow editing.

In step S8, the executing unit 44 performs a cooperative edit of the specified document file in the storage unit 14 by a plurality of users in accordance with the instruction from the storage controller 42. The cooperative edit is performed as depicted, for example, in FIG. 5A described above.

In step S9, if the executing unit 44 detects that one of the users who are cooperatively editing the specified document file performs an operation of closing the specified document file, it is determined that the cooperative edit is completed, and the executing unit 44 notifies the storage controller 42 of the completion of the cooperative edit.

In step S10, the storage controller 42 performs control to upload the specified document file in the storage unit 14 onto the one of the external apparatuses 52 and store the specified document file, which has been uploaded, in the one of the external apparatuses 52. As described above, upon storing the specified document file in the one of the external apparatuses 52, the storage controller 42 performs control to allow the specified document file to be used in the one of the external apparatuses 52 (that is, check-in is performed).

In step S11, the storage controller 42 notifies the accepting unit 40 that the information about the specified document file has been updated. For example, the storage controller 42 notifies the accepting unit 40 that the number of users who are cooperatively editing the specified document file has been updated.

In step S12, in accordance with the notification of the update described above, the accepting unit 40 updates the information about the specified document file, which is presented on the acceptance screen 60 depicted, for example, in FIG. 8 described above, and completes the processing.

In this way, according to the present exemplary embodiment, when a user performs a cooperative edit operation on a document file stored in the external apparatuses 52, the user is only required to instruct the information processing apparatus 10 to perform the cooperative edit operation. Thus, since the user is not required to perform cumbersome operations such as download and upload of the document file in addition to performing the cooperative edit operation, the amount of operational load for the user is reduced, and the cooperative edit operation is efficiently performed.

The information processing apparatus according to the exemplary embodiment has been described by way of example. The exemplary embodiment may be embodied by a program that causes a computer to execute a function of each unit included in the information processing apparatus. The exemplary embodiment may be embodied by a computer readable recording medium storing such programs.

Further, the configuration of the information processing apparatus described in the above exemplary embodiment is intended only to be illustrative and may be modified in accordance with circumstances within the spirit of the present disclosure. For example, the terminal apparatus and the information processing apparatus according to the present exemplary embodiment may be integrated into a single unit.

The processing flow of the program described in the above exemplary embodiment is also intended to be illustrative. An unnecessary step may be removed, a new step may be added, or a process order may be changed within the spirit of the present disclosure.

In addition, in the above exemplary embodiment, the case where the processing according to the exemplary embodiment is realized by using a software configuration in which a computer executes a program has been described, but this is not meant to be limiting. The exemplary embodiment may be realized, for example, by using a hardware configuration or a combination of a hardware configuration and a software configuration.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory, and
a processor programmed to
accept from a terminal apparatus of a first user an instruction to perform a predetermined operation on data stored in an external apparatus;
in accordance with the instruction, perform control to retrieve the data from the external apparatus and store the data in a storage unit in the information processing apparatus;
perform the operation on the data, which is stored in the storage unit, in accordance with the instruction; and
perform control to store in the external apparatus the data on which the operation has been performed in accordance with the instruction.

2. The information processing apparatus according to claim 1,
wherein, upon storing the data in the storage unit, the processor performs control to forbid the data from being used in the external apparatus, and
after storing in the external apparatus the data on which the operation has been performed in accordance with the instruction, the processor performs control to allow the data to be used in the external apparatus.

3. The information processing apparatus according to claim 2,
wherein, after the data is stored in the storage unit, the processor accepts from a terminal apparatus of a second user that differs from the first user an instruction to perform an operation on the data, and
performs the operation on the data in accordance with the instruction accepted from the terminal apparatus of the second user.

4. The information processing apparatus according to claim 3,
wherein, upon detecting completion of an operation performed on the data in accordance with an instruction accepted from a terminal apparatus of a last user, the processor performs control to store the data in the external apparatus.

5. The information processing apparatus according to claim 1,
wherein, when accepting from the terminal apparatus of the first user the instruction to perform the operation on the data, the processor accepts a result of a choice between whether the data is used by a single user or by a plurality of users.

6. The information processing apparatus according to claim 2,
wherein, when accepting from the terminal apparatus of the first user the instruction to perform the operation on the data, the processor accepts a result of a choice between whether the data is used by a single user or by a plurality of users.

7. The information processing apparatus according to claim 3,
wherein, when accepting from the terminal apparatus of the first user the instruction to perform the operation on the data, the processor accepts a result of a choice between whether the data is used by a single user or by a plurality of users.

8. The information processing apparatus according to claim 4,
wherein, when accepting from the terminal apparatus of the first user the instruction to perform the operation on the data, the processor accepts a result of a choice between whether the data is used by a single user or by a plurality of users.

9. The information processing apparatus according to claim 1,
wherein, upon accepting from the terminal apparatus of the first user the instruction to perform the operation on the data, the processor compares a first data stored in the external apparatus and a second data stored in the storage unit and, if the second data is not older than the first data, the processor does not perform control to store the first data in the storage unit, and the processor performs the operation on the second data in accordance with the instruction.

10. The information processing apparatus according to claim 1,
wherein, after the processor stores in the external apparatus the data on which the operation has been performed in accordance with the instruction, if the data in the external apparatus is updated, the processor performs control to delete the data stored in the storage unit.

11. The information processing apparatus according to claim 1,
wherein the processor causes the terminal apparatus of the first user to display an acceptance screen including thumbnails of a plurality of pieces of data stored in the external apparatus, each of the thumbnails representing one of the plurality of pieces of data, and accepts the instruction to a piece of data that is selected from the plurality of pieces of data.

12. The information processing apparatus according to claim 11,
wherein the acceptance screen presents each of the plurality of pieces of data stored in the external apparatus in a manner that enables distinguishing a piece of data stored in the storage unit from a piece of data that is not stored in the storage unit.

13. The information processing apparatus according to claim 11,
wherein the acceptance screen presents the number of users each of whom is issuing an instruction to perform an operation on the data stored in the storage unit.

14. The information processing apparatus according to claim 11,
wherein the acceptance screen presents the data stored in the storage unit in a manner that enables determining whether the data allows a cooperative edit.

15. A non-transitory computer readable medium storing a program causing a computer to function as each unit included in the information processing apparatus according to claim 1.

16. An information processing apparatus comprising:
means for accepting from a terminal apparatus of a user an instruction to perform a predetermined operation on data stored in an external apparatus;
means for performing control to retrieve the data from the external apparatus and store the data in a storage unit in the information processing apparatus, in accordance with the accepted instruction;
means for performing the operation on the data, which is stored in the storage unit, in accordance with the instruction; and
means for performing control to store in the external apparatus the data on which the operation has been performed in accordance with the instruction.
